(19) United States
(12) Patent Application Publication
(10) Pub. No.: US 2024/0039140 A1
(43) Pub. Date: Feb. 1, 2024

(54) Modular Antenna for an RFID Reading Device

(71) Applicant: SICK AG, Waldkirch (DE)

(72) Inventor: Florian PUDENZ, Waldkirch (DE)

(21) Appl. No.: 18/219,285

(22) Filed: Jul. 7, 2023

(30) Foreign Application Priority Data
Aug. 1, 2022 (EP) 22188151.9

(51) Int. Cl. H01Q 1/22; H01Q 9/04; G06K 19/07; G06K 19/077

(52) U.S. Cl. CPC H01Q 1/2225; H01Q 9/0407; G06K 19/0723; G06K 19/07749

(57) ABSTRACT

A modular antenna having specified dimensions and antenna properties for an RFID reading device is provided that has a housing and a base element inserted into the housing, wherein a coupling element having at least one infeed point, a terminal for a radio frequency line, and a radio frequency connection between the terminal and the infeed point is arranged on the base element. The base element here is inserted in a housing of the specified dimensions from a plurality of different housings and a radiator from a selection of different radiators is inserted into the housing at a coupling distance from the coupling element, with the radiator having the specified antenna properties in interaction with the base element and the housing.

The invention relates to a method of manufacturing a modular antenna and to a modular antenna respectively.

RFID reading devices serve for the identification of objects and products and are used inter alia to automate logistical movements. RFID transponders fastened to the products are read out at an identification point, above all on a change of the owner of the product or on a change of the transport means, and information is optionally written back into the transponder. The detected information is used to control the forwarding and sorting of goods and products. Important applications for automatic identification are logistics distribution centers, for instance of package shippers, or the baggage check-in at airports.

The RFID reading device excites RFID transponders located in its reading range by electromagnetic radiation via its antenna to emit the stored information, receives the corresponding transponder signals and evaluates them. For this purpose, the UHF (ultra-high frequency) range is frequently used since there is an established framework here in the standard ISO 18000-6 and in addition transponders at different distances from some millimeters up to several meters can be read out. UHF RFID transponders are available in very compact construction designs and can also accordingly be attached to very small objects.

The respective application situation requires different properties and designs of the RFID reading device since, for example, RFID transponders have to be read from different directions and at different distances and different amounts of construction space are available for an RFID reading device. Product families having respective device variants for the different applications are accordingly conventionally provided. A respective separate antenna has previously been required for the device variants here. The available volume for the setup of an antenna has a decisive influence on its possible properties. Respective antennas have therefore been developed that differ in their dimensions to achieve the best antenna properties for a given volume, for instance with respect to the antenna gain. The development includes individual components of the antenna that are especially developed to a design. This results in a large number of different components and thus longer development times since the components for each antenna type are individually optimized again, additionally via the service life of the product with respect to increased effort in product care, storage, and material availability.

U.S. Pat. No. 1,745,342 describes how the directivity of a dipole antenna can be improved by additional resonators. General optimization options thus result as to how they can be utilized in the just described conventional development; however, the effort for the individual optimization of respective antennas for each specific design of an RFID reading device does not thereby become less.

EP 2 790 269 A1 discloses a patch antenna having a planar resonator element that has a complex structure of slots and projections. A further patch antenna is known from EP 2 811 575 A1 that has a slot structure folded into a two-dimensional pattern to feed and/or tap an electromagnetic signal. They are two examples of documents that present antennas optimized for an RFID reading device. The optimizations are specific to the device so that, as explained, there is a substantial effort for development and product care over a larger product family.

An antenna is described in EP 3 553 886 A1 having a dielectric substrate at whose one surface an antenna element is arranged and at whose other surface a ground element is arranged having a metal plate at a spacing from the antenna element that is larger than the mass element. A special adaptation to an RFID reading device, let alone a product family, is not addressed.

WO 2005/034290 A1 deals with a modular patch antenna that has a first module having a metal layer, a dielectric layer, and a metallic mass layer and a second module having a frame. Alternatively, only a dielectric layer or the same three layers as in the first module can be provided in the second module. This provides an only extremely limited flexibility that is not sufficient for a product family of RFID reading devices.

It is therefore the object of the invention to provide an improved antenna for an RFID reading device.

This object is satisfied by a method of manufacturing a modular antenna and by a modular antenna in accordance with the respective independent claim. The modular antenna is manufactured with specified or desired dimensions and with specified or desired antenna properties. The dimensions permit certain designs and thus also installation positions of the antenna or of an RFID reading device having the antenna. The antenna properties include, for example, frequency range, gain, aperture angle, axial ratio, front to back ratio, adaptation, and/or voltage standing wave ratio (VSWR).

A plurality of base elements are manufactured that are of the same type as each other. For this purpose, a coupling element, a terminal, and a radio frequency connection are arranged therebetween on the respective base element. The coupling element radiates an RFID signal in the assembled antenna via a radiator or it receives it. The antenna can be connected to a transceiver via a radio frequency line at the terminal. The radio frequency connection, for example at least one microstrip line, conducts radio frequency signals in both directions between the coupling element and the terminal. The connection can be direct or at least one further element is provided between the coupling element and the terminal. The base element is in particular a correspondingly mounted circuit board.

One of the base elements produced in this manner is subsequently inserted into a housing. This can take place some distance in time and at a different location; the manufacture of the base elements and the assembly of an antenna from such a base element are decoupled from one another in principle. Depending on the embodiment, the housing is, for example, an antenna housing of an external antenna or the housing of an RFID reading device having an internal antenna.

The invention starts from the basic idea of equipping a modular antenna of one of the base elements that are of the same type as one another with individual properties in that different housings or radiators are used. A plurality of different housings are kept in store that can each take up the base element. The specified design or the specified dimensions is/are achieved by selection of a specific housing. A plurality of different radiators are correspondingly kept in store that can each cooperate with the base element or with its coupling element. Each radiator preferably fits in every housing, but it is also conceivable that at least one of the radiators can only be inserted in specific ones of the housings, i.e. that then only specific combinations of radiators and housings are possible. One of the radiators is selected and is inserted into the housing in a coupling position, in particular at a coupling distance, with respect to the coupling element. The radiator is preferably connected in a non-conductive manner.

A conceivable selection is the dispensing with of a radiator. The coupling element then radiates RFID signals or receives them directly. Sufficient antenna properties are frequently not achieved thereby so that a radiator is nevertheless preferably selected and used.

A modular antenna of the specified design or dimensions having the specified antenna properties is manufactured by the selection of the housing and radiator. The manufacture can also be understood in the sense of a conversion since then a new antenna having specified dimensions and antenna properties is likewise produced. The base element is preferably inserted into a new housing, the housing is converted, and/or a different radiator is used without tools here.

The invention has the advantage that a particularly simple, flexible and cost-effective antenna design is made possible. The base element as the most complex part of an antenna only has to be developed once. It preferably covers a plurality of frequency ranges in advance and can be used in different designs. It can be manufactured in larger volumes and thereby less expensively in comparison with individually developed antennas. Only individual components such as the housings and radiators have to be individually developed. Such components can highly likely be reused for the design of a new antenna. Different demands of the target application, in particular with respect to the design, installation position, and available construction space can be serviced by different designs of the housings. The possible antenna properties are likewise flexible due to housing properties, properties of the radiator, and further possible individual modifications still to be described. Even retroactive conversions are possible by the modular approach to retroactively adapt an already used RFID reading device to changed demands by an accessory part; for example, because the reading range is to be increased.

The plurality of different housings preferably differ from one another in size, geometry, an installation position for the base element, and/or an installation position for a radiator. The design and dimensions of the antenna determine the size or geometry so that the specified dimensions can be observed by selection of a suitable housing. The installation position for the base element and a radiator fix the mutual coupling position and the position with respect to the housing. The installation position for a radiator can moreover determine which radiators can be inserted in this housing.

A housing part is preferably added, removed, or replaced. A housing or the antenna is thus converted instead of replacing the whole housing. An example is the placement or removal of a hood having at least one installation position for a radiator. An antenna can thus be converted or upgraded with the aid of housing parts.

The plurality of different radiators preferably differ from one another in size, geometry, intended lateral position with respect to the coupling element, intended distance from the coupling element, and/or additional dielectric material. The size and geometry have an influence on the antenna properties achieved with the radiator and on the possible housings and installation positions within the housings where the radiator can be inserted. The intended lateral position and the intended distance from the coupling element correspond to the installation position that a housing provides. An additional dielectric material on the front and/or rear surface of the radiator again modifies the antenna properties.

At least some of the stored radiators are preferably arranged on their own circuit boards. This in particular provides the possibility of arranging different radiators on similar circuit boards. The intended installation position in a housing can thus be the same for different radiators in a simple manner and the insertion into a housing is standardized. The radiator preferably does not have any electric connection to the coupling element; accordingly, no electric contact of the circuit board to the base element or its circuit board has to be made.

The selected radiator is preferably attached to an inner wall of the housing. A radiator in the form of a metal film is adhered to an inner wall, for example. The stored plurality of different radiators can be any desired mixture of radiators on a kind of circuit board or a plurality of kinds of circuit boards, without circuit boards, and for direct attachment to an inner wall of the housing.

At least one additional resonator is preferably inserted into the housing. The housing preferably has at least one suitable installation position for this purpose. The resonator supports the radiator or the radiator and the at least one resonator together functionally form the actual radiator. The at least one additional resonator thus provides degrees of freedom to achieve the specified antenna properties. The use of at least one additional resonator is in particular possible to convert or upgrade an antenna.

A conductive surface is preferably introduced into the housing as a ground plane. The housing preferably has at least one suitable installation position for this purpose. The ground plane forms a second conductive layer electrically insulated from the conductive surface of the base element with the coupling element. A ground plane can already be part of the base element, for example a layer of a multilayer circuit board of the base element, or a part of the housing. This is either an alternative to a ground plane first used or the ground planes complement one another. There must be an electrically easily conductive connection between a plurality of ground planes. The conductive surface then effectively increases the size of the ground plane of the base element and/or of the housing. The size, geometry, and positions of the ground plane or of the connected ground planes generally influence the antenna properties, in particular improve the antenna gain. The ground plane thus provides further degrees of freedom to achieve the specified antenna properties.

The coupling element is preferably configured as an antenna patch. The antenna thus becomes a modular patch antenna. The antenna patch has a size, geometry, position, and other design that matches all the radiators of the plurality of stored radiators to cover a large range of antenna properties.

A power divider network, in particular with a polarization control logic, is preferably arranged on the base element. The power divider network or feed network is connected between the terminal and the coupling element via the radio frequency connection now divided into two. The coupling element now has a plurality of infeed points. The infeed points can be supplied with specific powers and phases by a polarization control logic that, for example, has a plurality of radio frequency lines and radio frequency switches. The antenna can thereby be operated with different polarization properties, in particular polarized linearly in a preferred direction such as polarized horizontally and vertically or circularly clockwise or counterclockwise.

The coupling element is preferably arranged on the one surface and the power divider network on the other surface of the base element. The base element can thereby be formed as particularly compact; the coupling element can in particular use substantially the whole surface of the base element.

The terminal is preferably connected to an RFID control and evaluation unit via a transceiver to manufacture an RFID reading device with the antenna. Depending on the embodiment, the antenna is thus operated as an external antenna of an RFID reading device with a transceiver and a required RFID control logic or the transceiver and the RFID control logic are installed in the housing to set up an RFID reading device with an internal antenna. The antenna is used by the RFID reading device to transmit RFID signals to an RFID transponder and/or to receive RFID signals from an RFID transponder. The RFID control and evaluation unit that has at least one digital processing module such as a microprocessor, an FPGA (field programmable gate array), an ASIC (application specific integrated circuit) or the like is configured for the encoding of RFID information into the RFID signals and/or to read out RFID information from the RFID signals. The transceiver and the RFID control and evaluation unit can form a common processing module or can at least partially use a processing module together. Such an RFID reading device is preferably used in a stationary installation at a reading zone of a conveyor or of a reading portal for reading out at least one RFID transponder moved on the conveyor or through the reading portal. It is simply possible to manufacture a modular antenna that is suitable for the reading application due to the antenna concept in accordance with the invention.

The modular antenna for an RFID reading device in accordance with the invention, that is preferably manufactured by the method in accordance with the invention has the specified dimensions and antenna properties by selection of a suitable housing and radiator. An RFID reading device having a transceiver and an RFID control and evaluation unit is particularly preferably provided that uses the modular antenna as an internal or external antenna. All the described designs, embodiments, and dependent claims of the manufacturing process are correspondingly transferable to the modular antenna in accordance with the invention and to the RFID reading device in accordance with the invention and vice versa.

The invention will be explained in more detail in the following also with respect to further features and advantages by way of example with reference to embodiments and to the enclosed drawing. The Figures of the drawing show in:

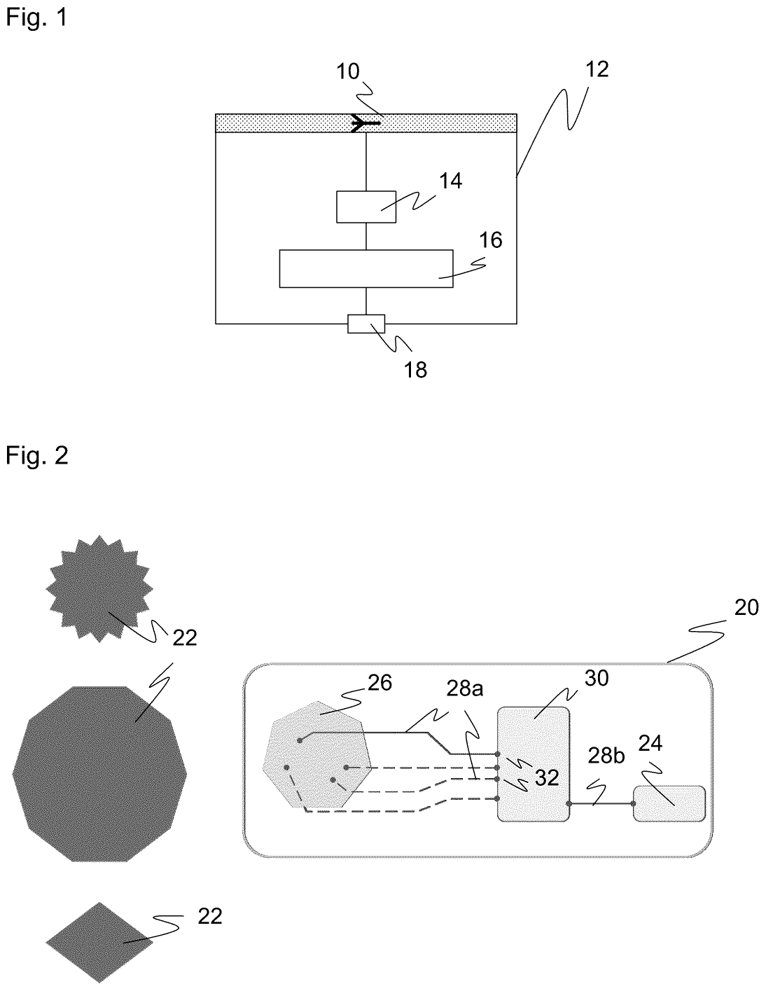

FIG. 1 a schematic representation of an RFID reading device with a modular antenna;

FIG. 2 a schematic representation of a base element for manufacturing a modular antenna having different radiators combinable therewith;

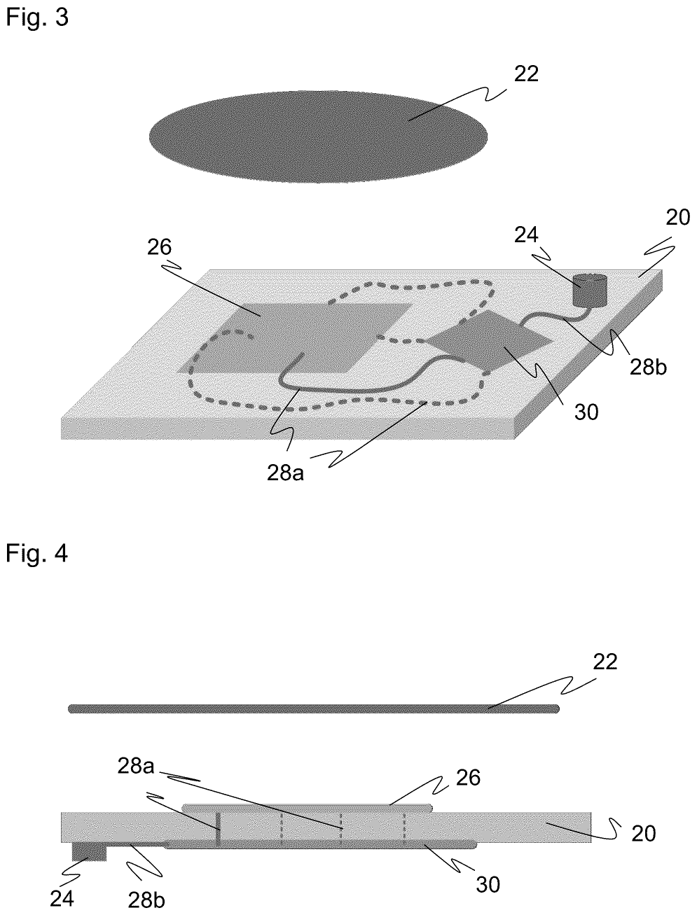

FIG. 3 a schematic three-dimensional view of a modular antenna of a base element and a radiator selected therefor;

FIG. 4 a sectional view of a modular antenna;

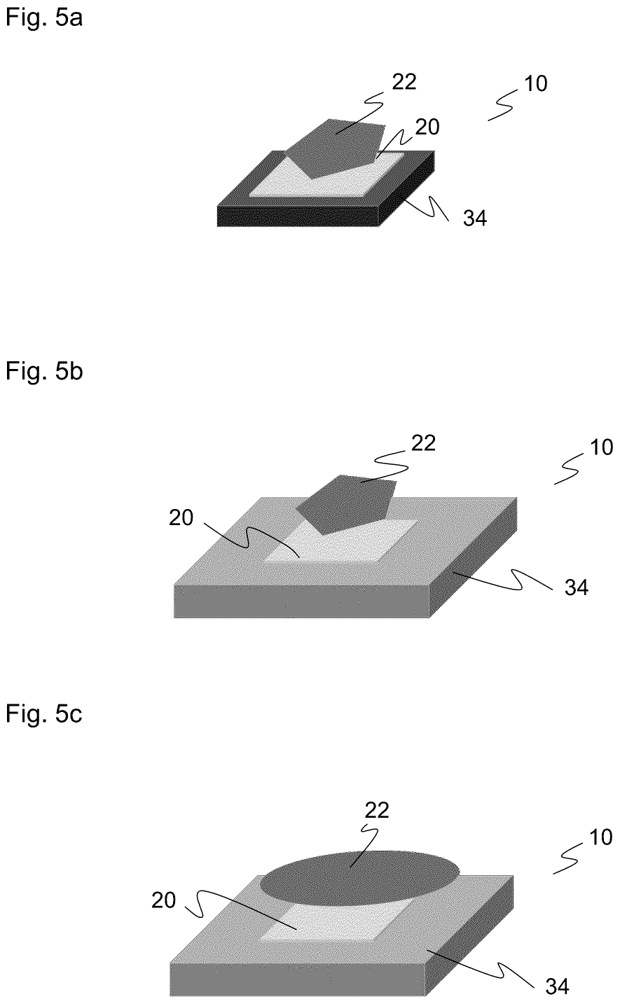

FIG. 5a a schematic three-dimensional view of a variant A of a modular antenna having a compact housing and radiator;

FIG. 5b a schematic three-dimensional view of a variant B of a modular antenna having a larger housing and a compact radiator;

FIG. 5c a schematic three-dimensional view of a variant C of a modular antenna having a larger housing and a larger radiator;

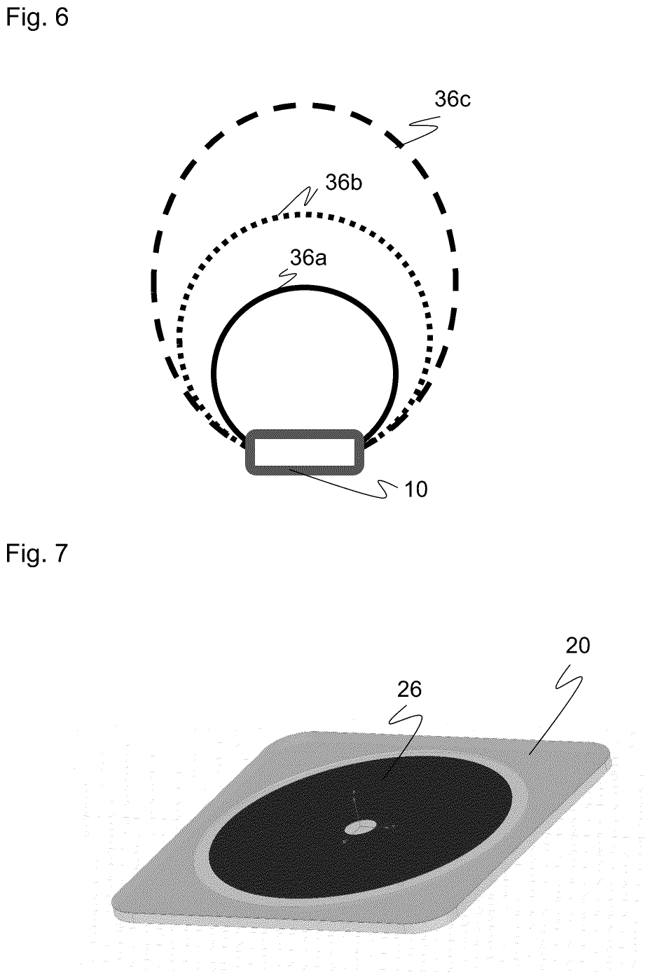

FIG. 6 a schematic representation of the different antenna characteristics for the variants A to C in accordance with FIGS. 5a-c;

FIG. 7 an exemplary three-dimensional view of a base element with a circular antenna patch as the coupling element;

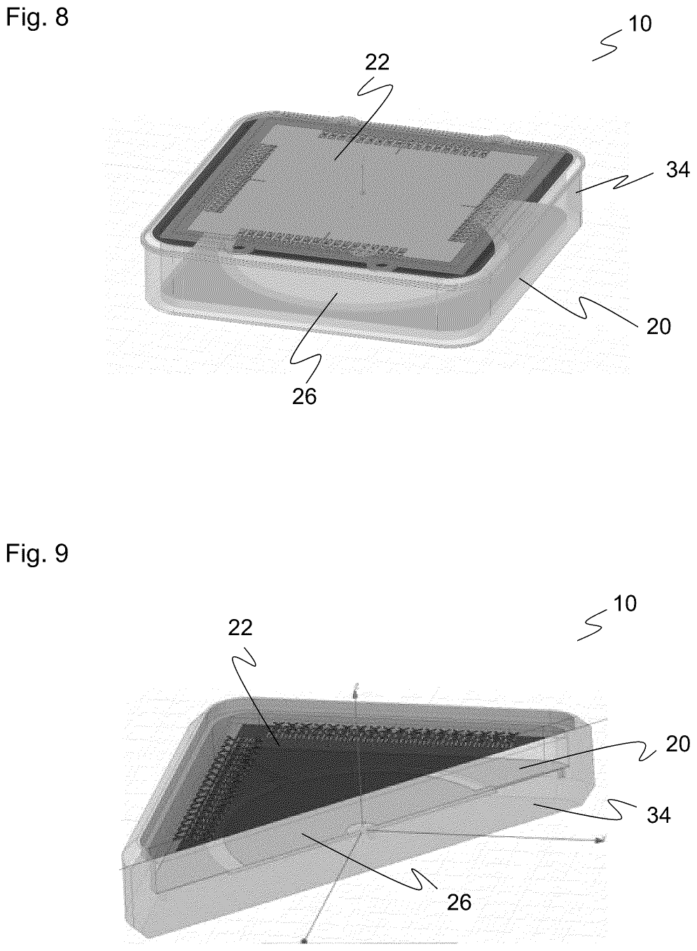

FIG. 8 an exemplary three-dimensional view of a modular antenna of variant A;

FIG. 9 a sectional view of the modular antenna in accordance with FIG. 8;

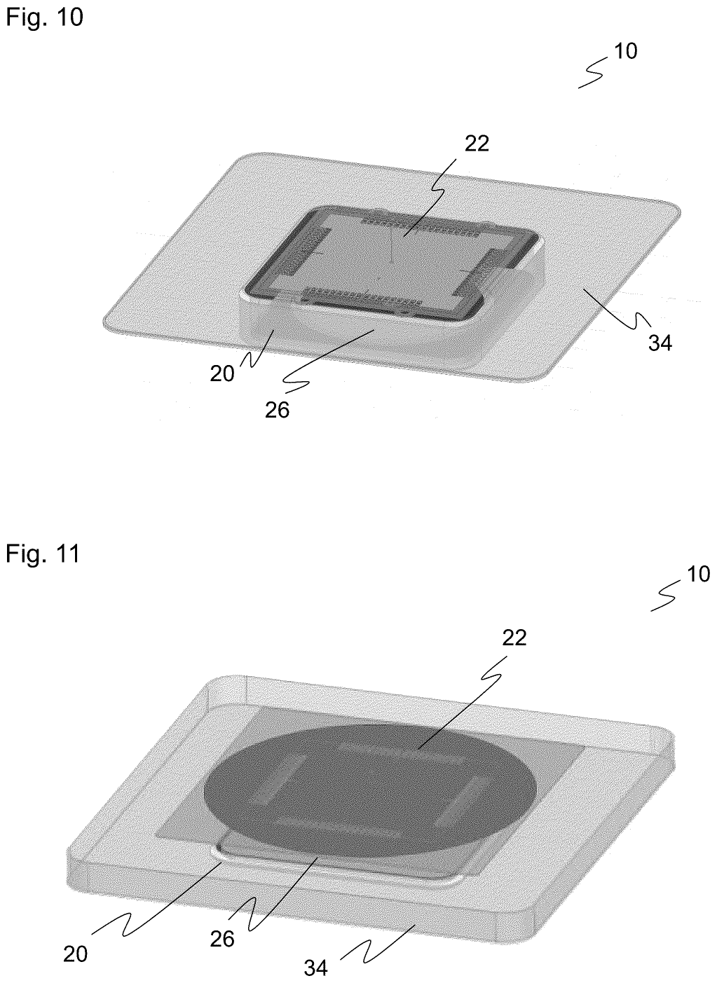

FIG. 10 an exemplary three-dimensional view of a modular antenna of variant B;

FIG. 11 an exemplary three-dimensional view of a modular antenna of variant C;

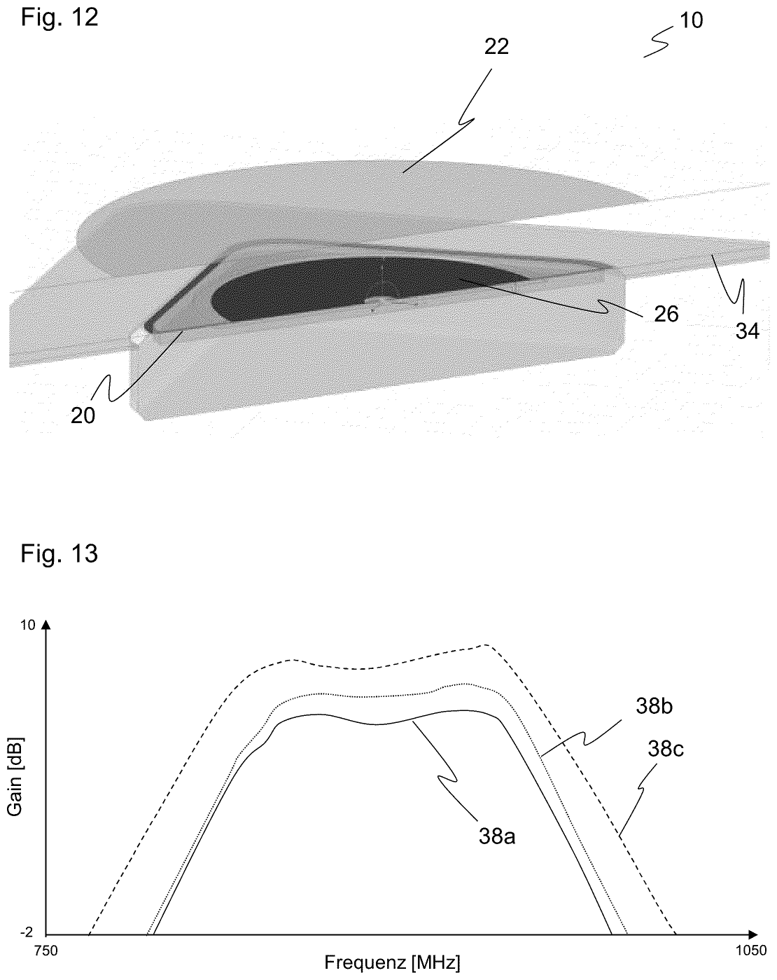

FIG. 12 a sectional view of the modular antenna in accordance with FIG. 11;

FIG. 13 a comparative representation of the antenna gain in the main direction of radiation in dependence on the frequency for modular antennas of variants A to C;

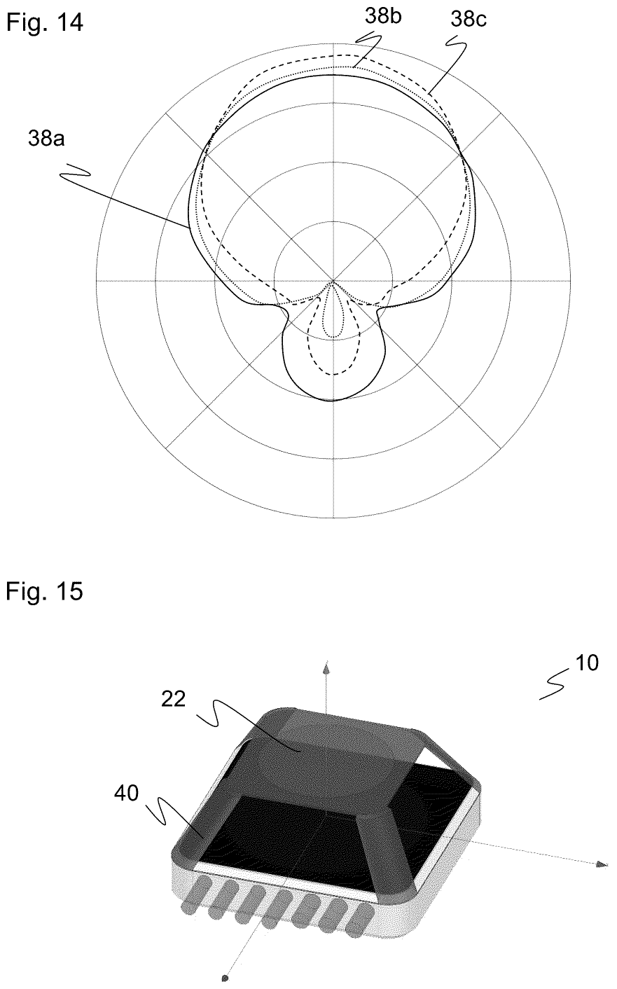

FIG. 14 comparative radiation patterns for modular antennas of variants A to C at a frequency of 900 MHz;

FIG. 15 a three-dimensional representation of an antenna having an exemplary patch resonator that can be placed on;

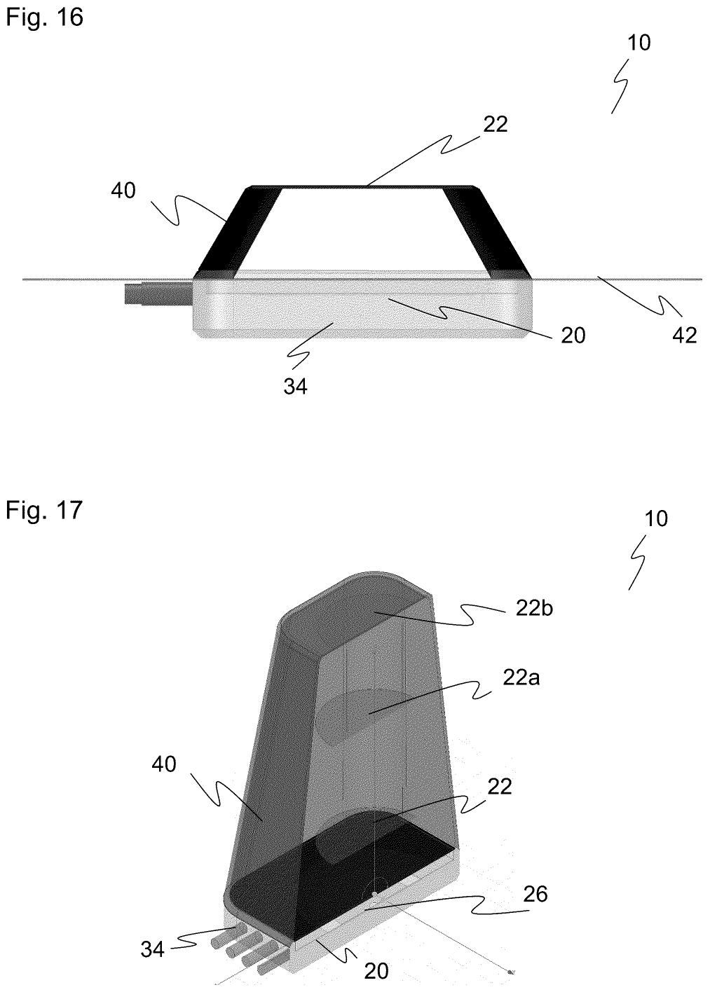

FIG. 16 a sectional view of an antenna having a patch resonator placed on and an additionally inserted ground plane;

FIG. 17 a three-dimensional representation of an antenna having a further exemplary hood that can be placed on and having three resonators; and

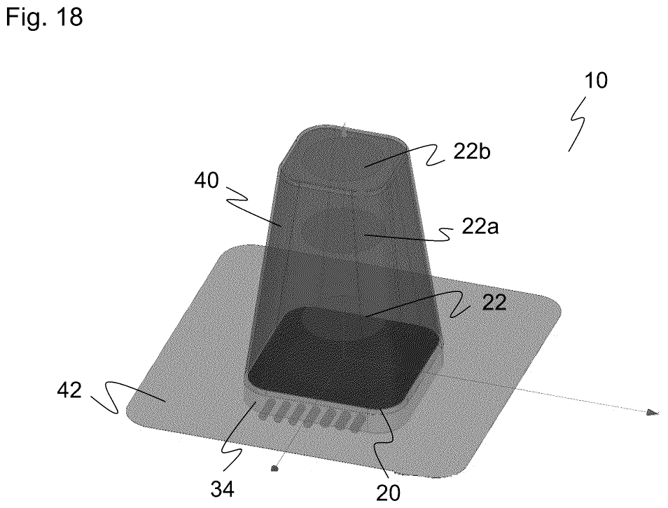

FIG. 18 a three-dimensional representation of an antenna having a hood placed on and an additionally inserted ground plane.

FIG. 1 is a schematic representation of a modular antenna 10 in an RFID reading device 12. A transceiver 14 is connected to the antenna 10 and a control and evaluation unit 16 of the RFID reading device 12 is connected to it to evaluate RFID signals received by means of the antenna 10 or to transmit information to a transponder as RFID signals. The control and evaluation unit 16 is furthermore connected to a wired or wireless interface 18 to exchange data, to carry out parameterizations, and the like.

The mode of operation of an RFID reading device, for example for the UHF frequency range (ultrahigh frequency) in accordance with the standard IS 18000-6 is known per se and will therefore not be explained in more detail The invention relates to the antenna 10 or to its manufacture such as subsequently described in detail with reference to the further FIGS. 2 to 18. An external antenna is also conceivable instead of the internal antenna 10 shown, with then the transceiver 14 and control and evaluation unit 16 being accommodated in at least one further housing separate from the antenna 10 and connected via a cable.

FIG. 2 is a schematic representation of a base element 20 for manufacturing a modular antenna 10 having different radiators combinable therewith 22. A terminal 24 for a radio frequency line by which the antenna 10 can be connected to the transceiver 14, a coupling element 25 for coupling radio frequency signals to a further element, not electrically connected, such as a selected one of the radiators 22, and a radio frequency connection 28a-b between the terminal 24 and the coupling element 26 are arranged on the base element 20.

The base element 20 is, for example, a circuit board having at least one electrically conductive layer. It can moreover have a second conductive layer, not shown and insulated therefrom as a ground plane. With a small design, the base element 20 should contain as many components as follows that can be used in the same manner for the design of a modular antenna 10 in a large number of antenna variants. The base element 20 is therefore not only optimized for a certain characteristic of the modular antenna 10, but is rather adapted such that it works at least sufficiently well for different designs for different installation situations and desired antenna properties. The same base element 20 can thus be manufactured in advance in a larger volume and can be used in a plurality of different modular antennas 10 that are individualized by further components such as a selected radiator 22, a housing, and further additional elements still to be described.

The terminal 24 can be designed as a plug or as a socket for a coaxial cable, as a coupling structure for a hollow conductor, or as a contact surface for a soldered or plug-in connection, in particular to a circuit board of the transceiver 14. The radio frequency connection 28 preferably has at least one microstrip line. A power divider network 30 is optionally provided between the terminal 24 and the coupling element 26; the radio frequency connection 28 is then in two parts and, on the one hand. connects the terminal 24 to the power divider network 30 and, on the other hand, now connects the power divider network 30 to the coupling element 26 via a plurality of ports 32 and associated paths. The coupling element 26, in particular an antenna patch, is designed for the interaction with different radiators 22 in accordance with the usability of the base element 20 in a manner that is as universal as possible. The radio frequency signals are forwarded on the base element 20 to the coupling element 26 and are there coupled into metallic structures such as at least one radiator 22. A directed irradiation of the electromagnetic signals away from the base element 20 or from its ground plane results. If the optional power divider network 30 is provided, the coupling element 26 has a plurality of infeed points corresponding to the ports 32. The division of the radio frequency signal, for example by radio frequency switches, can be used by a polarization logic of the power divider network 30 to generate or to receive electromagnetic waves of different polarizations.

The radiators 22 can be implemented on a further circuit board that does not require any electrically conductive contact to the base element 20. Alternatively, metallic structures are conceivable that are combined with components that are anyway present, for example as a self-adhesive metalized film on an inner side of a cover or of a housing. Radiators 22 can, for example, be implemented at the same resonant frequency in different sizes by the use of additional dielectrics or compact antenna structures such as in EP 2 790 269 A1 named in the introduction.

The antenna parameters or antenna properties of the different variants of a modular antenna 10 result from the combination of the respective same base element 20 with at least a selected one of the different radiators 22. The dimensions and shape of the radiator 22, its positions, and above all its distance from the base element 20, as well as a possible additional dielectric material on the front and/or rear surfaces play a role here. As already mentioned, further components such as the housing, additional resonators, additional metallic surfaces as a ground planes or a reflector likewise have an influence on the antenna properties. The differentiation of the antenna properties can take place via components that can be produced with as little material effort or manufacturing effort as possible, for example without a further circuit board or with simple circuit boards without additional mounted components. The base element 20 and its components, in particular the coupling element, could likewise be varied to change antenna properties; however, the respective same base element 20 is used instead.

FIG. 3 shows a schematic three-dimensional view of a modular antenna 10 of a base element 20 to which now one of the radiators 22 has been selected and arranged in a suitable position with respect to the coupling element 26. A housing, not shown here, having corresponding mounts preferably provides for the remaining of the base element 20 and the coupling element 26 in the respective positions.

FIG. 4 shows a sectional view of a modular antenna 10. It largely corresponds to the modular antenna 10 of FIG. 3. However, some components, here the coupling element 26, on the one hand, and the power divider network 30, on the other hand, are now arranged on the front surface and the rear surface of a circuit board of the base element 20. A base element 20 in accordance with this embodiment can remain even more compact.

FIGS. 5a-c show three variants A to C of a modular antenna 10 very schematically. Only the base element 20 is respectively shown that is the same over variants A to C with its coupling element 26 and the radiator 22 selected for it in accordance with variant A to C or the housing 34 selected for it, with only a portion that acts as a ground plane or as a reflector being shown that is relevant to the antenna properties. FIG. 5a shows variant A having a compact radiator 22 and a compact housing 34; FIG. 5b shows variant B having a compact radiator 22 and a larger housing 34 with a larger conductive surface; and FIG. 5c shows variant C with a larger radiator 22 and a larger housing 34. It is understood that only a small selection of possible combinations is thus shown to illustrate the principle; the most varied radiators 22 and/or housings 34 can be combined. Modular antennas 10 of the most varied designs and antenna properties can thereby be set up, for instance with respect to the frequency range, antenna gain, aperture angle, axial ratio, front to back ratio, adaptation and/or voltage standing wave ratio (VSWR).

FIG. 6 shows a schematic representation of the different antenna characteristics for the variants A to C in accordance with FIGS. 5a-c; The solid line 36a corresponds to variant A of FIG. 6a; the dotted line 36b to variant B of FIG. 5b; and the dashed line 36c to variant C of FIG. 5c.

FIG. 7 shows a simulation model of an exemplary base element 20 as a multilayer circuit board having dimensions of 120 mm×120 mm with a circular patch of 94 mm diameter as the coupling element 26 on the upper side. The feed or radio frequency connection 28a-b is here implemented by vias and microstrip lines on the rear circuit board side or in a lower layer of the circuit board. The dimensions of the base element 20 determine the minimal possible dimensions of the variants of a family of modular patch antennas 10 designed therewith. It would be conceivable in a particularly simple embodiment to use the base element 20 directly as an antenna 10, that is not to combine a radiator 22 therewith. The efficiency expressed as the antenna gain in comparison with the utilized volume thus becomes comparatively poor, however. This would be conceivable for applications having a very short reading distance from the RFID transponders or for a targeted avoidance of overreaches, for instance with a sales counter in retail with a placing of the RFID transponders to be read. At least one radiator 22 is preferably combined for most of the real application situations to improve the antenna properties.

FIGS. 8 to 12 show the purely schematic variants A to C of the modular antenna 10 in accordance with FIG. 5a-c again in more detailed simulation modules.

The base element 20 shown in FIG. 7 is respectively accommodated in an upwardly open metallic housing 34 and a radiator 22 is arranged thereabove. Different radiators 22 and housings are used in variants A to C, with the distance of the radiator 22 being able to remain the same or to be different over the variants. The housing 34 can alternatively not be metallic; the aperture angle of the antenna 10 is thereby increased in size and the antenna gain in the main direction of radiation is correspondingly reduced.

FIG. 8 shows an exemplary three-dimensional view of variant A of the antenna 10 and FIG. 9 shows an associated sectional view. The radiator 22 is relatively small here, is similarly dimensioned to the patch of the coupling element 26, and a correspondingly small housing 34 is used. The small-part structure of the radiator 22 is only to be understood as an arbitrary example just like its specific shape and size overall.

FIG. 10 shows an exemplary three-dimensional view of variant B of the antenna 10. The radiator 22 is the same as in variant A; the freedom of choice of the radiator 22 was thus utilized in this example of variant B. The housing 34, however, has an enlarged metallic surface or, in an alternative observation that differs only in terms and not technically, such a metallic surface has been added, in particular as a corresponding housing part. This additional reflector surface increases the antenna gain, reduces the aperture angle of the antenna 10, and increases the front to back ratio.

FIG. 11 shows an exemplary three-dimensional view of variant C of the antenna 10 and FIG. 12 shows an associated sectional view. An enlarged housing 34 is furthermore used as in variant B and the radiator 22 is now also considerably larger and moreover has a simple circular shape instead of the roughly rectangular, in detail very complex structure of variants A and B. As in all the embodiments, the specific design of the radiator 22 of variant C is to be understood purely as an example.

FIG. 13 shows a comparative representation of the antenna gain in dependence on the frequency for modular antennas 10 of variants A to C in accordance with the simulation models presented with respect to FIGS. 8 to 12. The solid line 38a here corresponds to variant A In accordance with FIGS. 8 and 9; the dotted line 38b to variant B In accordance with FIG. 10; and the dashed line 38c to variant C In accordance with FIGS. 11 and 12. The antenna gain (circular polarized realized gain in dBic, i.e. including losses in the materials and lines used, not only the directivity; indeed in the direction of the main beam with theta=0°, phi=0°) is entered as a function of the frequency in an ultrahigh frequency range between approximately 800 MHz and 1000 MHz

Since all the variants A to C use the same base element 20, the different antenna gains and the partially greater bandwidths are due to the different radiators 22 or housings 34. As the size of these individual components increases, the antenna gain becomes greater. Variant A in the desired frequency band of 865 MHz to 928 MHz reaches a gain of 6.1 dBic, variant B reaches 7.1 dBic, and variant C reaches 8.2 dBic. For comparison, a gain of approximately −5 dBic is achieved in the same frequency band with the base element 20 alone, that is without a radiator 22 and without an additional ground plane of a housing 34.

FIG. 14 shows, with the same convention of the lines 38a-c as in FIG. 13, comparative direction diagrams for modular antennas 10 of variants A to C at a frequency of 900 MHz It can clearly be recognized that as the antenna gain changes, the 3 dB aperture angle and the ratio of the power irradiated to the front and back (front to back ratio) also change.

The adaptation of the antenna properties is not possibly solely by an installation of the base element 20 in different housings 34, but also by the assembly of accessories at already set up antennas 10. This is then not restricted to the production, but rather enables a particularly simple conversion or upgrading in the field. FIGS. 15 to 18 show some exemplary variants of accessories.

FIG. 15 is a three-dimensional representation of an antenna 10 having an exemplary patch resonator that can be placed on. It can here be the radiator 22 or an additional resonator. A type of hood 40 is preferably provided for the housing 34 that moves the resonator into a suitable position at the intended distance from the coupling element 26. The shape of the hood 40 as a truncated pyramid is to be understood as an example, but is particularly suitable for a frequent parallelepiped shape of the housing 34.

FIG. 16 shows a sectional view of an antenna 10 having a patch resonator placed on similar to that of FIG. 15 and having an additionally inserted ground plane 42 that can be part of the housing 34 or can be subsequently installed. The ground plane 42 further modifies the antenna properties and this modification can be varied by material, size, shape, and position of the ground plane.

FIG. 17 shows a three-dimensional representation of an antenna 10 having a further exemplary hood 40 that can be placed on and having three resonators 22, 22a, 22b. The additional resonators 22a-b further adapt the antenna properties. It is conceivable to permit a variable number of resonators, 22a-b and different sizes, shapes, and positions in the hood 40 or variants of a hood to thus obtain further individual antennas 10.

FIG. 18 shows a three-dimensional representation of an antenna 10 having a hood 40 that can be placed on and having three resonators 22, 22a, 22b and an additional metallic ground plane 42. The modification possibilities of FIGS. 16 and 17 are thus so-to-say combined for illustration.

The respective resonators do not require any conductive connection and permit a certain tolerance in the positioning. This simplifies an installation, even a tool-less installation, for example by a hood 40 of plastic, in which the resonators are latched and held in position by resilient elements such as a snap or click closure.

The ground plane of FIGS. 16 and 18 can be assembled by metallic, conductive connections, for example screws, to provide the conductive connection and to achieve the desired improvement of the antenna properties.

1. A method of manufacturing a modular antenna having specified dimensions and antenna properties for an RFID reading device, wherein a plurality of base elements of the same type as one another are first manufactured on which a coupling element having at least one infeed point, a terminal for a radio frequency line, and a radio frequency connection between the terminal and the infeed point are respectively arranged and one of the base elements is subsequently inserted into the housing,
wherein a plurality of different housings are kept in store and a housing having the specified dimensions is selected to insert the base element into the housing;
and wherein a plurality of different radiators are kept in store and no radiator or one of the radiators is selected and is inserted into the housing in a coupling position relative to the coupling element, to manufacture a modular antenna having the specified dimensions and antenna properties by the respective selection.

2. The method in accordance with claim 1,
wherein the plurality of different housings differ from one another in size, geometry, an installation position for the base element, and/or an installation position for a radiator.

3. The method in accordance with claim 1,
wherein a housing part is added, removed, or replaced.

4. The method in accordance with claim 1,
wherein the plurality of different radiators differ from one another in size, geometry, intended lateral position with respect to the coupling element, intended distance from the coupling element, and/or additional dielectric material.

5. The method in accordance with claim 1,
wherein at least some of the stored radiators are arranged on their own circuit boards.

6. The method in accordance with claim 1,
wherein the selected radiator is attached to an inner wall of the housing.

7. The method in accordance with claim 1,
wherein at least one additional resonator is inserted into the housing.

8. The method in accordance with claim 1,
wherein a conductive surface is introduced into the housing as a ground plane.

9. The method in accordance with claim 1,
wherein the coupling element is configured as an antenna patch.

10. The method in accordance with claim 1,
wherein a power divider network is arranged on the base element.

11. The method in accordance with claim 10,
wherein the power divider network has a polarization control logic.

12. The method in accordance with claim 1,
wherein the coupling element is arranged on the one surface and the power divider network is arranged on the other surface of the base element.

13. The method in accordance with claim 1,
wherein the terminal is connected to an RFID control and evaluation unit via a transceiver to manufacture an RFID reading device having the antenna.

14. A modular antenna having specified dimensions and antenna properties for an RFID reading device, wherein the modular antenna has a housing and a base element inserted into the housing, wherein a coupling element having at least one infeed point, a terminal for a radio frequency line, and a radio frequency connection between the terminal and the infeed point are arranged on the base element,
wherein the base element is inserted in a housing of the specified dimensions from a plurality of different housings; and
wherein no radiator or a radiator from a selection of different radiators is inserted into the housing at a coupling distance from the coupling element, with the radiator having the specified antenna properties in interaction with the base element and the housing.

15. An RFID reading device having an antenna that has a transceiver connected to the terminal and an RFID control and evaluation unit connected to the transceiver, wherein the modular antenna having specified dimensions and antenna properties for an RFID reading device, wherein the modular antenna has a housing and a base element inserted into the housing, wherein a coupling element having at least one infeed point, a terminal for a radio frequency line, and a radio frequency connection between the terminal and the infeed point are arranged on the base element,
wherein the base element is inserted in a housing of the specified dimensions from a plurality of different housings; and
wherein no radiator or a radiator from a selection of different radiators is inserted into the housing at a coupling distance from the coupling element, with the radiator having the specified antenna properties in interaction with the base element and the housing.
